(19) United States
(12) Patent Application Publication
(10) Pub. No.: US 2003/0177174 A1
(43) Pub. Date: Sep. 18, 2003

(54) Target resource allocation in an iSCSI network environment

(75) Inventors: James P. Allen, Austin, TX (US); William Christopher Conklin, Georgetown, TX (US); Robert G. Kovacs, Austin, TX (US); Shawn Patrick Mullen, Buda, TX (US); Rakesh Sharma, Austin, TX (US)

Correspondence Address: BRACEWELL & PATTERSON, L.L.P., P.O. BOX 969, AUSTIN, TX, 78767-0969, US

(73) Assignee: International Business Machines Corporation, Armonk, NY

(21) Appl. No.: 10/099,778

(22) Filed: Mar. 14, 2002

(51) Int. Cl. G06F 15/16

(52) U.S. Cl. 709/203

(57) ABSTRACT

A method, system, and computer program product applicable within a server for adaptively allocating target resources in a network environment. In accordance with the method of the present invention, a storage name server triggers a forced target rediscovery evolution during competing sessions in which multiple initiator nodes are communicatively connected to a target node utilizing an associated network target address.

The target rediscovery mechanism is triggered in response to session feedback received from one or more competing initiator nodes or the object target node. Responsive to the received session feedback, the storage name server issues session interruption instructions, and replaces the network target address associated with the target node with a different network target address. Finally, a target rediscovery message is issued to the competing initiator nodes, wherein the target rediscovery message directs the initiator nodes to rediscover available target nodes in accordance with associated network target addresses.

### BACKGROUND OF THE INVENTION

1. Technical Field

The present invention relates in general to data storage networking systems, and in particular to dynamically altering data storage network topology. More particularly, the present invention relates to a system and method for using forced rediscovery of data storage targets to control initiator access thereto.

2. Description of the Related Art

Small Computer System Interface (SCSI) is well known in the art of data processing systems as a set of evolving ANSI standard electronic interfaces that allow personal computers to communicate with peripheral hardware such as disk drives, tape drives, CD-ROM drives, printers, scanners, etc. SCSI is a parallel interface providing faster data transmission rates than other standard serial and parallel ports. Since many devices can be attached to a single SCSI port, SCSI effectively serves as an input/output (I/O) bus as well as an interface.

The proliferation of networked data storage devices, such as within storage area networks (SANs), has given rise to the development of Internet SCSI (iSCSI). iSCSI is a new Internet Protocol (IP)-based storage networking standard for linking data storage facilities, developed by the Internet Engineering Task Force (IETF). By carrying commands over IP networks, iSCSI is used to facilitate data transfers over internets and intranets and to manage data storage over long distances. The iSCSI protocol is among the key technologies expected to bring about rapid development of the SAN market, by increasing capabilities and performance of stored data transmission. The ubiquity of IP networks enables iSCSI to be used for data transmission over local area networks (LANs), wide area networks (WANs), or the Internet, and furthermore enables location-independent data storage and retrieval.

A problem common to most shared access network environments is that of controlling access to network server and data resources. Such control is necessary to prevent undesirable or possibly malicious client access to resources, and also to enforce agreed upon quality of service (QoS) and prioritization metrics for subscribing clients. In an iSCSI network environment, a discovery mechanism is utilized to moderate client access to data resources. The iSCSI discovery mechanism employs an iSCSI-specific naming convention for all iSCSI network nodes. An iSCSI node is the main addressable, discoverable entity in an iSCSI environment. An iSCSI node can be either a client (referred to hereinafter as an “initiator”), a data resource (referred to hereinafter as a “target”), or both. The iSCSI name for a target uniquely identifies the target as a storage resource accessible to the initiators, and the iSCSI name for an initiator uniquely identifies the initiator for the purpose of target resource allocation (i.e. which initiator has access to which target).

Although related, the concept of iSCSI names is separate from iSCSI addresses. An iSCSI name is a location-independent, permanent identifier for an iSCSI node. iSCSI names are associated with iSCSI nodes instead of with network adapter cards to ensure the free movement of network host bus adapters between hosts without carrying over the SCSI state information. An iSCSI node therefore has one iSCSI name, which remains constant for the life of the node. As utilized herein, the terms “initiator name” and “target name” refer to this permanent iSCSI name. An iSCSI address specifies the location of a node as well as the iSCSI name of that node. Typically, the iSCSI address includes a host name or IP address, a TCP port number (for a target), and the iSCSI name of the node. Unlike the iSCSI name, which is permanently associated with a particular node, the TCP/IP portion of anode's iSCSI address can be changed. As utilized herein, the terms “initiator address” and “target address” refer to the changeable IP address/TCP port number portion of an iSCSI address.

The goal of iSCSI discovery is to allow an initiator to find the targets that it may access, and at least one address at which each available target may be accessed. Sub-goals of iSCSI discovery include providing low overhead support for small iSCSI setups, and scalable discovery solutions for large enterprise setups. Thus, there are several methods that may be used to find targets ranging from configuring a list of targets and addresses on each initiator and doing no discovery at all, to configuring nothing on each initiator, and allowing the initiator to discover targets dynamically. The present invention relates is applicable to the latter iSCSI enterprise-scale environment, in which initiators must dynamically discover targets.

Storage name servers are consolidated information repositories that typically provide for discovery and management of iSCSI storage devices in an enterprise-scale IP storage network wherein each storage device subordinates its discovery and management responsibilities to the storage name server. Mechanisms by which the storage name server implements controlled access from initiators to targets include so-called “discovery domains” and login control services. A discovery domain service facilitates the partitioning of initiator devices into more manageable groupings for administrative and login control purposes. This allows an administrator to limit the login process to the suitable subsets of targets registered in the storage name server. Login control entails the target node downloading the list of authorized initiator devices from the storage name server. Only initiator nodes or devices that match the required identification and authentication information provided by the storage name server are permitted access by that target node during session establishment.

The above-described target discovery and login control services provide a centralized target access control mechanism that selectively enables or excludes particular initiator devices to/from establishing a data transfer session with initiators. However, this mechanism does not address problems arising from runtime QoS or security issues arising during a data transfer session. For example, a first initiator may be consuming excess bandwidth at the expense of a second, higher-priority initiator attempting to access the same target. Conventional iSCSI discovery and login control may address such problems during initialization of subsequent data sessions requested by the first initiator, but are not suited to correcting the problem during a given session.

It would be useful to address QoS problems arising from initiator connectivity to targets during on-going iSCSI sessions. Furthermore, it would be particularly useful to implement a target resource allocation mechanism that seamlessly leverages extant storage name server and iSCSI target discovery functionality.

### SUMMARY OF THE INVENTION

A method, system, and computer program product applicable within a server for adaptively allocating target resources in a network environment are disclosed herein. In accordance with the method of the present invention, a storage name server triggers a forced target rediscovery evolution during competing sessions in which multiple initiator nodes are communicatively connected to a target node utilizing an associated network target address. The target rediscovery mechanism is triggered in response to session feedback received from one or more competing initiator nodes or the object target node. Responsive to the received session feedback, the storage name server issues session interruption instructions, and replaces the network target address associated with the target node with a different network target address. Finally, a target rediscovery message is issued to the competing initiator nodes, wherein the target rediscovery message directs the initiator nodes to rediscover available target nodes in accordance with associated network target addresses.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a block diagram depicting storage area networks in which target resources may be adaptively allocated in accordance with a preferred embodiment of the present invention;

FIG. 2 is a block diagram illustrating iSCSI network entities utilized to implement adaptive target resource allocation in accordance with a preferred embodiment of the present invention;

FIG. 3 is a flow diagram depicting steps performed by the network entities shown in FIG. 2 during session initialization and processing in accordance with a preferred embodiment of the present invention; and

FIG. 4 is a flow diagram illustrating utilization of a forced target rediscovery mechanism for implementing target resource allocation in accordance with a preferred embodiment of the present invention.

### DETAILED DESCRIPTION OF THE PREFERRED EMBODIMENT

This invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

As explained in further detail with reference to the figures, the present invention is directed to improving target storage device resource allocation in a shared access network environment. Preferred embodiments are illustrated and described herein in the context of an Internet Small Computer System Interface (iSCSI) storage network. It should be noted that the inventive principles disclosed herein are more widely applicable to analogous client-server architectures in which clients “discover” targets as rendered available by an independently operating intermediary server.

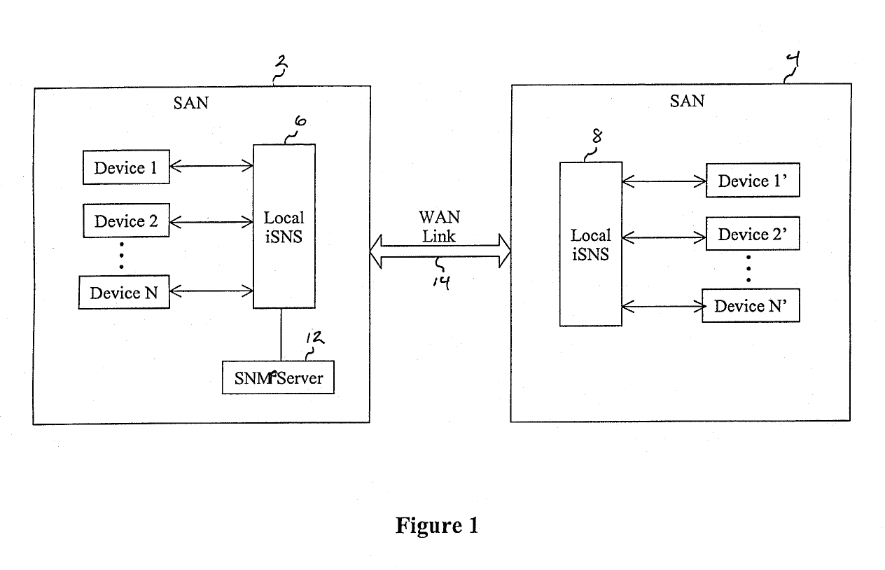

With reference now to the figures, and in particular with reference to FIG. 1, there is depicted a block diagram illustrating an iSCSI environment in which a forced rediscovery mechanism is utilized to adaptively allocate target resources in accordance with a preferred embodiment of the present invention. The iSCSI environment shown in FIG. 1 is embodied in a wide area network (WAN) 10 which includes first and second storage area networks (SANs) 2 and 4. Local SAN 2 comprises a local internet storage name server 6 that is communicatively connected to multiple network devices 1-N and a Simple Network Management Protocol (SNMP) server 12. Internet Protocol (IP) local area network (LAN)/WAN routers (not depicted) may be utilized by a WAN link 14 to extend connectivity of SAN 2 devices 1-N to SAN 4 within WAN 10. The IP connectivity of SAN 2 to SAN 4 permits remote disk access for storage utilities, synchronous and asynchronous remote mirroring, and remote backup and restore for tape vaulting. Within WAN 10, Transport Control Protocol (TCP) can be utilized end-to-end over IP to avoid the need for specialized equipment for protocol conversion, to ensure data reliability, to cope with network congestion, and to provide retransmission strategies adapted to WAN delays.

SAN 4 also includes an internet storage name server 8 communicatively connected to network devices 1′-N′. In accordance with the depicted embodiment, network devices 1-N and 1′-N′ contain one or more iSCSI nodes, wherein each iSCSI node represents a single iSCSI initiator or iSCSI target. As utilized herein, a “session” refers generally to one or more logical connections (TCP/IP connections, for example) that link an initiator device with a target. The initiator/target nodes within network devices 1-N and 1′-N′ are each identified by their respective iSCSI names. The iSCSI name is independent of the location of the object node (initiator or target), and is used to provide: an initiator identifier for configurations that provide multiple initiators behind a single IP address; a target identifier for configurations that present multiple targets behind a single IP address; and a method to it recognize multiple paths to the same device over different IP addresses and ports. The initiator and target nodes within network devices 1-N and 1′-N′ also have addresses. An iSCSI address specifies a single path to its respective node and maybe represented in several formats including IPv4, IPv6, or a host name.

In order for an iSCSI initiator to establish an iSCSI session with an iSCSI target, the initiator needs the IP address and iSCSI target name information. To facilitate and control access by initiator nodes to target nodes within WAN 10, storage name servers 6 and 8 include processing and program functionality for implementing a target discovery mechanism which allows an initiator to find the targets to which it has access, and at least one address at which each available target can be accessed. It is assumed in the embodiments described with reference to FIGS. 1-4, that the discovery mechanism is designed to operate in a “zero configuration” environment in which an initiator does not have pre-configured target identification and network location information for available targets. In such a configuration, the initiators within network devices 1-N and 1′-N′ send discovery request messages to storage name servers 6 and 8 to obtain lists of one or more available target nodes that meet the criteria set forth in the requests.

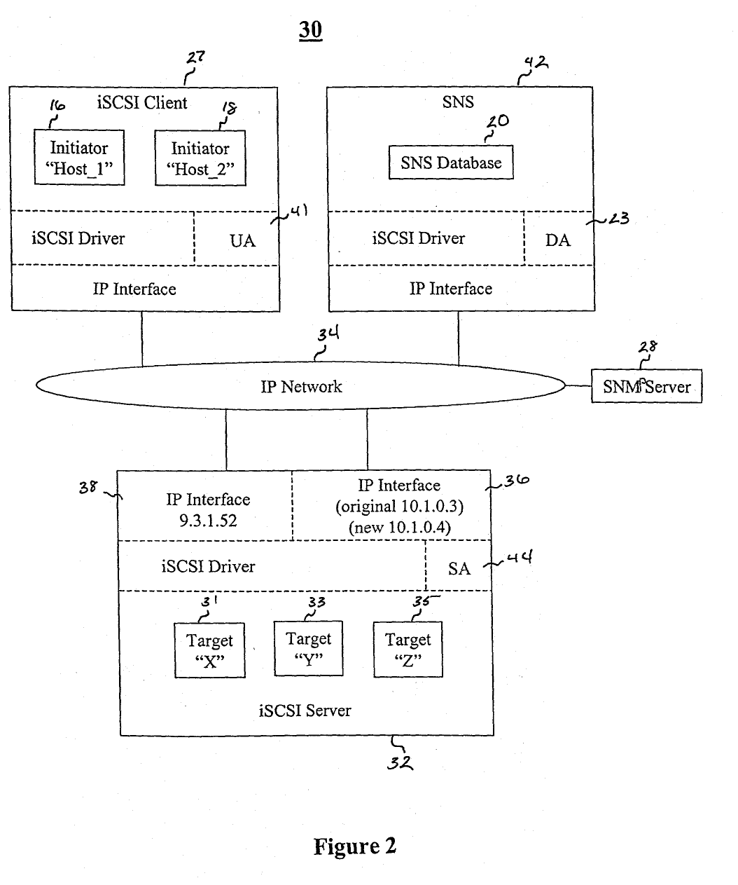

Referring now to FIG. 2, there is depicted a more detailed block diagram illustrating iSCSI network entities utilized to implement adaptive target resource allocation in accordance with a preferred embodiment of the present invention. Specifically, FIG. 2 depicts an iSCSI-based SAN 30 that includes a storage name server 42 which includes processing and program functionality for implementing session management, including target discovery moderation, for an iSCSI client 27 and an iSCSI server 32. In accordance with iSCSI convention, iSCSI client 27 is a logical entity, typically a host, which includes at least one initiator. Although not expressly depicted in FIG. 2, it is understood by those skilled in the art that one or both of iSCSI client 27 and iSCSI server 32 may be co-resident within data storage devices. An IP network 34 provides connectivity from iSCSI client 27 to iSCSI server 32, which is also a logical entity (typically a storage controller or gateway for a storage device), and includes at least one iSCSI target.

As further illustrated in FIG. 2, iSCSI client 27 includes a pair of initiator nodes 16 and 18 having iSCSI initiator names “Host_{—}1” and “Host_{—}2”, respectively. Strictly speaking, an “initiator” is a logical entity, typically in the form of a device driver within a host, that sends SCSI commands (READ, WRITE, etc.) to targets to be executed. In FIG. 2, initiator nodes 16 and 18 are depicted distinctly from an iSCSI driver 26 for purposes of illustration. In accordance with iSCSI convention, iSCSI names “Host_{—}1” and “Host_{—}2” specify, respectively, the worldwide unique name of initiator nodes 16 and 18.

iSCSI server 32 includes three target nodes 31, 33, and 35 having iSCSI target names “X”, “Y”, and “Z”, respectively. Each target node represents a logical entity, typically situated within a storage controller or gateway, that receives and executes SCSI commands sent from an initiator. SCSI commands are delivered from initiator nodes 16 and 18 to target nodes 31, 33, and 35 during iSCSI sessions. Storage name server 42 facilitates the establishment of session connections by providing a consolidated target and initiator identification database from which targets 31, 33, and 35 can be discovered by initiators 16 and 18, and initiators 16 and 18 can be recognized by targets 31, 33, and 35 for login authentication. The initiators within iSCSI client 27 and the targets within iSCSI server 32 therefore subordinate a significant portion of their discovery and management responsibilities to storage name server 42.

As part of establishing an iSCSI session with a target in SAN 30, an initiator such as either initiator node 16 or 18, must determine the target name and address. To this end, the initiator node may deliver a discovery request to storage name server 42. In accordance with the depicted embodiment, an initiator node may or may not have the iSCSI target name of the desired target resource, but in either case, does not have its address. A discovery request from an initiator node may include the iSCSI name of the initiator as a filter to obtain addresses for the available targets. iSCSI server 32 has three targets that initiator node 16 could discover, named “X”, “Y”, and “Z”. iSCSI client 27 may use initiator name “Host_{—}1” or “Host_{—}2” in a discovery request as a filter to discover only targets that are configured, in accordance with discovery domain information maintained within storage name server 42, to accept iSCSI connections from “Host_{—}1” or “Host_{—}2”.

As further shown in FIG. 2, iSCSI server 32 includes two IP interface adapters 38 and 36 that provide access to targets 31, 33, and 35 from IP network 34 using originally assigned IP addresses 9.3.1.52 and 10.1.0.3, respectively. Storage name server 42 utilizes the IP addresses assigned to IP interface adapters 38 and 36 to effectively permit each of targets 31, 33, and 35 to appear at one or both of the two possible IP addresses (i.e. each target would have one or two service Universal Resource Locator addresses). Therefore, in response to a target discovery request from iSCSI client 27, storage name server 42 may return the name of one or more of targets 31, 33, and 35, together with one or both of the IP addresses assigned to IP interface adapters 38 and 36. The target name and address information associated with target nodes 31, 33, and 35 is stored in a storage name server database 20 which also stores relevant initiator identification/authorization information.

In accordance with current iSCSI convention, an iSCSI-based SAN, such as SAN 30, provides a discovery mechanism that is facilitated by the use of so-called user agents, service agents, and directory agents. In the depicted embodiment, iSCSI client 27 includes a user agent 41 which may be characterized as a process working on behalf of initiators 16 and 18 to establish contact with some service. A service agent 44 is a process that advertises such service availability on behalf of targets 31, 33, and 35 within iSCSI server 32. A directory agent 23 within storage name server 42 acts as the centralized interface process which collects service advertisements from service agent 44 (and possibly other network service agents) and provides centralized access thereto by user agents including user agent 41.

An example of how targets are initially discovered by initiators prior to session establishment and subsequently rediscovered to advantageously reallocate network target resources is now described with continued reference to FIG. 2. In the following example of the initial target discovery process, it is assumed that storage name server 42 includes processing and storage functionality for dynamically altering the IP addresses assigned to target IP interface adapters 38 and 36. It is also assumed, that initiator device 16 is authorized in accordance with discovery domain information within storage name server 42 to establish a session with targets 31 and 33, and furthermore, that target 31 is only addressable at IP interface 36 while target 33 is addressable at both IP interface adapters 38 and 36. In response to a target discovery request from initiator 16 (including the initiator name “Host_{—}1” as the appropriate filter), storage name server 42 returns IP addresses 10.1.0.3 and 9.3.1.52 in association with target name “Y” and IP address 10.1.0.3 in association with target name “X”.

The availability of services between target 31 and target 33 may be ascertained by user agent 41 which retrieves service information applicable to targets 31 and 33 from either directory agent 23 or directly from service agent 44. If client 27 selects target 31 as the suitable target device for the requested data session, a login request is sent from initiator 16 to target 31, wherein the request includes the target name (i.e. “X”), the only available IP address (i.e. 10.1.0.3), and other information such as initiator identification. Assuming a successful login, the session commences with initiator node 16 issuing network encapsulated SCSI commands (e.g. Read, Write, etc.) which are received and processed by target node 31.

During the on-going session, problems relating to session bandwidth consumption, excessive delay, etc., resulting from session access to target 31 by other initiators, may necessitate a target resource allocation adjustment, and in this particular example, an adjustment in the availability of target 31 to initiator 16 and other currently connected initiators, as well as potential future initiators. The present invention provides a forced rediscovery mechanism that maybe implemented by a storage name server (or any server that maintains a database including target discovery related information) to effectuate a target resource reallocation among eligible initiators in accordance with ongoing session feedback received by the storage name server. In the foregoing example, such a rediscovery mechanism would include a session interruption step—storage name server 42 interrupting the currently established sessions between target node 31 and one or more initiator nodes (including initiator node 16) at originally assigned IP address 10.1.0.3. It should be noted that, as utilized herein, an “original” target address does not refer to the absolute first network address assigned to a target. Instead, “original” refers to the network address assigned to a target prior to a subsequent target rediscovery sequence wherein the network address is changed in accordance with the forced rediscovery mechanism disclosed herein.

Continuing with the foregoing example, the target rediscovery process continues with storage name server 42 replacing the network target address that was used to establish the interrupted sessions (i.e. IP address 10.1.0.3) with a replacement network target address, such as 10.1.0.4 for the IP interface in question. In one embodiment of the present invention, storage name server 42 effectuates the IP address replacement by associating the target node iSCSI name with the replacement IP address. Target node 31 is then bound to the newly assigned IP address. There are several ways known to those skilled in the art for binding a target device to a different IP address depending on various system configuration/administration factors. One possible approach is to de-configure the current IP address associated with IP interface adapter 36, and reconfigure IP interface adapter 36 with a different IP address. If the network administration of SAN 30 has adopted a pooled IP address approach, a different IP address can be programmatically assigned to IP interface adapter 36. Still another method for binding target node 31 to a different IP address is to simply change the port number (i.e. optional TCP portion of the TCP/IP address) at which IP interface adapter 36 receives transmissions bound for target node 31 while maintaining the original IP portion of the adapter network address.

After a different network address has been assigned and bound to target node 31, storage name server 42 sends to each of the affected initiator nodes one of two types of target rediscovery messages. The first type is a simple rediscover message instructing the initiator to reestablish the session with target node 31 at the newly assigned network address. The second type of rediscover message is optional, either instructing the object initiator to reestablish a session with target node 31 at an alternative network interface (such as IP interface 38) or to seek an alternative target device. This second rediscover message type is usually directed to one or more initiator nodes whose previous session activity was in some manner detrimental to network activity as determined by storage name server 42.

Storage name server 42 detects problematic initiator behavior in accordance with session feedback received from the object target node or one or more initiator nodes during session processing. In accordance with the preferred embodiment depicted in FIG. 2, such session feedback is received from the object target node or one or more of the connected initiator nodes in the form of a Simple Network Management Protocol (SNMP) Management Information Base (MIB) objects. An SNMP server 28 is employed within SAN 30 to execute management applications (not depicted) which monitor and control management agents within network elements such as iSCSI client 27, iSCSI server 32, and iSCSI storage name server 42. In this capacity, SNMP server 28 may facilitate the transmission of SNM MIBs from targets 31, 33, and 35, and initiators 16 and 18 to storage name server 42.

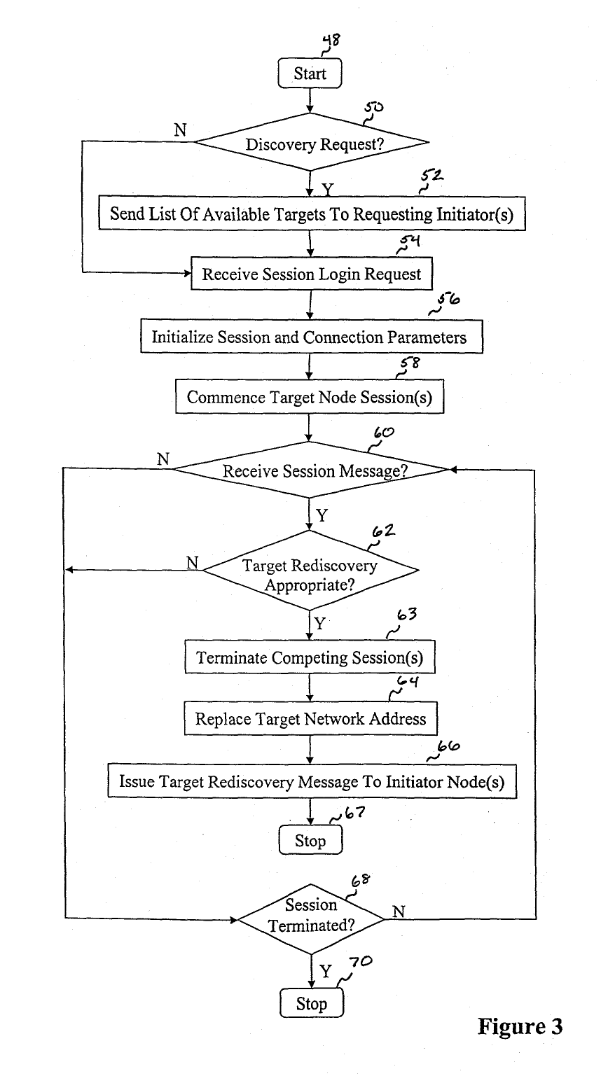

With reference to FIG. 3, there is illustrated a flow diagram depicting steps performed by the network entities shown in SAN 30 during session initialization and processing in accordance with a preferred embodiment of the present invention. Session initialization for one or both of initiators 16 and 18 begins as depicted at step 48 and proceeds to inquiry step 50 which illustrates whether or not target information is retrieved by initiator 16 or 18 using the previously described discovery process. In general terms, the possible target discovery request depicted at step 50 is undertaken when an iSCSI initiator requires contact information for potential iSCSI targets. Such contact information includes target availability and services offered by available targets.

Referring back to the example provided with reference to FIG. 2, assume that an initial target discovery request is delivered to storage name server 42 from initiator node 16. At step 52, and with the continued assumption that initiator node 16 may only access target nodes 31 and 33 in accordance with predetermined initiator access information stored within storage name server 42 (as per the established discovery domain to which initiator 16 belongs, for example), storage name server 42 responds to the discovery request by returning to initiator 16 the iSCSI names “X” and “Y” of targets 31 and 33, respectively. As previously explained with reference to FIG. 2, storage name server 42 delivers network IP addresses 9.3.1.52 and 10.1.0.3 in association with target name “Y”, while only network address 10.1.0.3 is delivered in association with target name “X”, as part of the step 52 discovery response.

Following initial target discovery steps 50 and 52 (including no discovery request being required if the target has pre-configured target name and address information), wherein user agent 41 has obtained the address of iSCSI server at which target 31 can be accessed, iSCSI server 32 receives a login request from user agent 41 on behalf of initiator 16 (step 54). Assuming a successful initiator authentication and authorization by target 31, the session connection parameters are initialized and the session is established as depicted at steps 56 and 58. The adaptive target resource allocation process of the present invention is implemented during one or more concurrently active sessions established over a single network address connection. Continuing with the foregoing example, it will be assumed that initiator 18 is engaged in an on-going session with target 31 which was established at the time that initiator 16 began its session with target 31 at step 58. Since target 31 is only accessible at IP address 10.1.0.3, initiators 16 and 18 must share the bandwidth available from IP interface 36.

The present invention envisions situations in which such shared bandwidth arrangements may become problematic over the course of the overlapping competing sessions. To enable recognition of such problems, and as depicted at step 60, session feedback in the form of session messages may therefore be received by storage name server 42. A potential problem arising from competing sessions may include prolonged, excessive bandwidth consumption on the part of one of the connected initiators, at the expense of the bandwidth requirements of the other connected initiators. Continuing with the foregoing example, and in accordance with one embodiment, the session message received by storage name server 42 at step 60 includes a rediscovery request from either initiator 18 or target node 31, delivered in response to detecting a significant imbalance in the bandwidth consumption of the competing sessions. In an alternate embodiment, the session message includes one or more session metrics relating to maximum, minimum, and/or average transmission rate, transmission error rate, and packet delay experienced by one or both of initiators 16 and 18. For the latter embodiment, storage name server 42 undertakes the task of determining whether or not the session metric is within a predetermined threshold to make a subsequent determination at step 62 of whether or not target rediscovery is required.

If, as depicted at step 63, target rediscovery is determined an appropriate response to session feedback, storage name server 42 issues a session termination command to iSCSI server 32, instructing server 32 to terminate all on-going sessions conducted over IP address 10.1.0.3 at IP interface 36. In addition, storage name server 42 replaces the network address registration of target node 31 with a different registered network address (step 64). Returning to the previous example, if the session message received at step 60 indicates that initiator 16 is engaged in undesirable session behavior, the sessions between initiators 16 and 18 and target 31 are terminated, and the original IP address 10.1.0.3 at which target 31 was originally registered is replaced by a different address, 10.1.0.4, available from a pool of dynamically assignable addresses (not depicted). Proceeding to step 66, storage name server 42 issues a target rediscovery message, which includes the iSCSI name and new IP address (i.e. 10.1.0.4) at which target 31 is now registered, to initiator node 18. Optionally, a rediscover message delivered to initiator 16 does not include the new IP address of target 31, but instead includes name and address information of other available targets (target 33, for example). In this manner, initiator node 18 is able to reestablish a session with target node 31 at its newly registered IP address while initiator node 16 must seek an alternative target node. Following issuance of the rediscovery messages, storage name server processing terminates as illustrated at step 67. If no session feedback requiring forced target rediscover is received by storage name server 42, the competing sessions eventually terminate and the process ends as shown at steps 68 and 70.

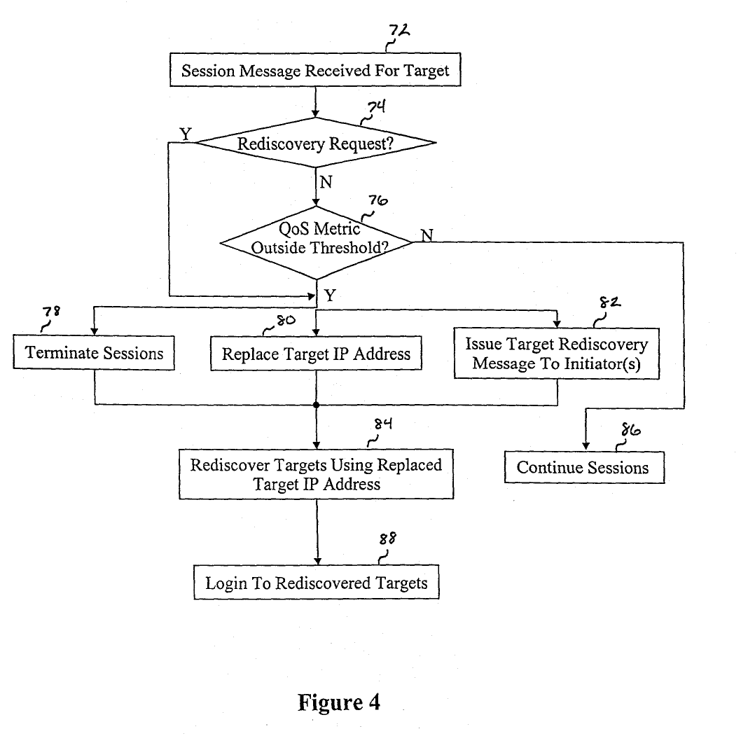

Referring to FIG. 4, there is depicted a flow diagram illustrating utilization of a forced target rediscovery mechanism for implementing target resource allocation in accordance with a preferred embodiment of the present invention. The forced target rediscovery process begins as shown at step 72 with a session feedback message being received by storage name server 42. Next, as illustrated at steps 74, storage name server 42 determines whether the session feedback message (delivered from one or more of multiple competing initiators or the object target) requires a target rediscovery. As depicted at steps 74 and 76, a direct rediscovery request by one of the session nodes, or a session metric that is outside a predetermined threshold, are two possible elements of a session message that trigger storage name server 42 to undertake a forced target rediscovery.

If storage name server 42 determines that the received session feedback message does not necessitate a forced target rediscovery, the ongoing competing sessions continue as illustrated at step 86. If, however, the session message triggers a target rediscovery response, storage name server 42 terminates the competing sessions at the given IP address interface (step 78), replaces the network address of the target node (step 80), and issues target rediscovery messages to the initiator nodes (step 82). Next, as depicted at steps 84 and 88, the initiators rediscover and login to available target nodes in accordance with the revised target address information delivered by storage name server 42.

Preferred implementations of the invention include implementations as a computer system programmed to execute the method or methods described herein, and as a program product. According to the computer system implementation, sets of instructions for executing the method and system of the present invention are resident in a storage device such as the ROM or RAM of computer processing systems within one or more networked nodes. Until required by the computer system, the set of instructions may be stored as a computer-program product in another computer memory, for example, in a disk drive (which may include a removable memory such as an optical disk or floppy disk for eventual utilization in disk drive).

A method and system have been disclosed for adaptively allocating target resources within an iSCSI network environment. Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the appended claims.

What is claimed is:

1. A method applicable within a server for adaptively allocating target resources in a network environment during concurrent sessions in which at least one initiator node is communicatively connected to a target node utilizing an associated network target address, said method comprising:
receiving a session message from one of the at least one initiator node or the target node; and
responsive to the received session message:
replacing the network target address associated with the target node with a different network target address; and
issuing a target rediscovery message to the at least one initiator node, wherein the target rediscovery message directs the at least one initiator node to rediscover available target nodes in accordance with associated network target addresses.

2. The method of claim 1, further comprising, responsive to the received session message, interrupting the concurrent sessions.

3. The method of claim 2, wherein said interrupting the concurrent sessions is performed in response to issuing the rediscovery message to the target node.

4. The method of claim 1, wherein said replacing the associated network target address comprises:
issuing an address change instruction to a target network adapter at which the concurrent sessions are connected at the associated network target address, wherein said address change instruction directs the target network adapter to bind itself to the different network target address; and
associating the target node with the replacement network target address within the server.

5. The method of claim 1, wherein the received session message is a rediscovery request.

6. The method of claim 1, wherein the received session message includes a simple network management protocol management information base object.

7. The method of claim 1, wherein the received session message includes a session metric, said method further comprising:
determining whether the received session metric is within a predetermined threshold; and
responsive to the received session metric being outside the predetermined threshold:
replacing the original network target address with a replacement network target address; and
issuing the target rediscovery message to the at least one initiator node.

8. The method of claim 7, wherein the session metric is a quality of service metric, wherein the quality of service metric relates to one or more of average transmission rate, maximum transmission rate, minimum transmission rate, transmission error rate, and network node delay.

9. The method of claim 1, wherein the target rediscovery message includes directing each of the at least one initiator node to discover target devices available to itself as determined by the association of the different network target address with the target node within the server.

10. A system for adaptively allocating target resources in a network environment during concurrent sessions in which at least one initiator node is communicatively connected to a target node utilizing an associated network target address, said system comprising:
processing means within a server for receiving a session message from one of the at least one initiator node or the target node; and
processing means within the server responsive to the received session message for:
replacing the network target address associated with the target node with a different network target address; and
issuing a target rediscovery message to the at least one initiator node, wherein the target rediscovery message directs the at least one initiator node to rediscover available target nodes in accordance with associated network target addresses.

11. The system of claim 10, further comprising, processing means within the server responsive to the received session message, for delivering a session interrupt message to the target node.

12. The system of claim 11, wherein the session interrupt message is delivered in response to issuing the rediscovery message to the target node.

13. The system of claim 10, wherein said processing means for replacing the associated network target address comprises:
processing means for sending an address change instruction to a target network adapter, wherein said address change instruction directs the target network adapter to bind itself to the different network target address; and
processing means for associating the target node with the replacement network target address within the server.

14. The system of claim 10, wherein the received session message is a rediscovery request.

15. The system of claim 10, wherein the received session message includes a simple network management protocol management information base object.

16. The system of claim 10, wherein the received session message includes a session metric, said system further comprising:
processing means within the server for determining whether the received session metric is within a predetermined threshold; and
processing means within the server responsive to the received session metric being outside the predetermined threshold for:
replacing the original network target address with a replacement network target address; and
issuing the target rediscovery message to the at least one initiator node.

17. The system of claim 16, wherein the session metric is a quality of service metric, wherein the quality of service metric relates to one or more of average transmission rate, maximum transmission rate, minimum transmission rate, transmission error rate, and network node delay.

18. The system of claim 10, wherein the target rediscovery message includes directing each of the at least one initiator node to discover target devices available to itself as determined by the association of the different network target address with the target node within the server.

19. A computer program product for adaptively allocating target resources in a network environment during concurrent sessions in which at least one initiator node is communicatively connected to a target node utilizing an associated network target address, said computer program product comprising:
program instruction means within a server for receiving a session message from one of the at least one initiator node or the target node; and
program instruction means within the server responsive to the received session message for:
replacing the network target address associated with the target node with a different network target address; and
issuing a target rediscovery message to the at least one initiator node, wherein the target rediscovery message directs the at least one initiator node to rediscover available target nodes in accordance with associated network target addresses.

20. The computer program product of claim 19, further comprising, program instruction means within the server responsive to the received session message, for delivering a session interrupt message to the target node.

21. The computer program product of claim 20, wherein the session interrupt message is delivered in response to issuing the rediscovery message to the target node.

22. The computer program product of claim 19, wherein said program instruction means for replacing the associated network target address comprises:
program instruction means for sending an address change instruction to a target network adapter, wherein the address change instruction directs the target network adapter to bind itself to the different network target address; and
program instruction means for associating the target node with the replacement network target address within the server.

23. The computer program product of claim 19, wherein the received session message is a rediscovery request.

24. The computer program product of claim 19, wherein the received session message includes a simple network management protocol management information base object.

25. The computer program product of claim 19, wherein the received session message includes a session metric, said computer program product further comprising:
program instruction means within the server for determining whether the received session metric is within a predetermined threshold; and
program instruction means within the server responsive to the received session metric being outside the predetermined threshold for:
replacing the original network target address with a replacement network target address; and
issuing the target rediscovery message to the at least one initiator node.

26. The computer program product of claim 25, wherein the session metric is a quality of service metric, wherein the quality of service metric relates to one or more of average transmission rate, maximum transmission rate, minimum transmission rate, transmission error rate, and network node delay.

27. The computer program product of claim 19, wherein the target rediscovery message includes directing each of the at least one initiator node to discover target devices available to itself as determined by the association of the different network target address with the target node within the server.
